(19) United States
(12) Patent Application Publication
(10) Pub. No.: US 2007/0133204 A1
(43) Pub. Date: Jun. 14, 2007

(54) ILLUMINATION DEVICE WITH HUE TRANSFORMATION

(75) Inventors: George R. Hulse, Arlington Heights, IL (US); Mark J. Cleaver, Milwaukee, WI (US)

Correspondence Address: STITES & HARBISON, PLLC, 400 W MARKET ST, SUITE 1800, LOUISVILLE, KY, 40202-3352, US

(73) Assignee: iLIGHT TECHNOLOGIES, INC., Chicago, IL (US)

(21) Appl. No.: 11/609,993

(22) Filed: Dec. 13, 2006

Related U.S. Application Data
(60) Provisional application No. 60/749,916, filed on Dec. 13, 2005.

(51) Int. Cl. F21V 1/00

(52) U.S. Cl. 362/235; 362/242; 362/84

(57) ABSTRACT

An illumination device includes a first light source, a second light source, and a light-diffusing medium. The first light source emits light of a first hue, and the second light source emits light of a second hue. The light-diffusing medium receives light emitted from the first and second light sources. The light-diffusing medium is composed of a light-transmitting material and a light color-converting material. The light color-converting material is selected to convert the light of a first hue into a light of a third hue, and to pass the light of the second hue with substantially no conversion. The light-diffusing medium thus emits light of a perceived hue that is a combination of the light of the third hue and the light of the second hue. By adjusting the relative intensities of the light emitted by the first and second light sources, the perceived hue can be readily transformed or tuned.

### CROSS-REFERENCE TO RELATED APPLICATIONS

The present application claims priority to U.S. Provisional Patent Application Ser. No. 60/749,916 filed on Dec. 13, 2005, the entire disclosure of which is incorporated herein by reference.

### BACKGROUND OF THE INVENTION

The present invention relates to illumination devices using light sources of different hues and a light-diffusing medium that includes a light color-converting material to produce a light of a desired hue.

The recent introduction of long-life, high-efficiency point light sources, as exemplified by high-intensity light-emitting diodes (LEDs), has provided lighting designers with great possibilities for both general illumination and special effects illumination. For example, commonly assigned U.S. Pat. Nos. 6,592,238 and 6,953,262, which are incorporated in their entirety herein by this reference, each describe an illumination device for simulating neon lighting having a plurality of spaced LEDs positioned adjacent the light-receiving surface of a rod-like member or waveguide. The rod-like member/waveguide is made of a material that preferentially scatters light entering the light-receiving surface such that the light intensity pattern exiting a light-emitting surface of the rod-like member/waveguide is substantially uniform.

Nevertheless, a problem with illumination devices using LEDs is that the available visible color spectrum is limited by the finite availability of LED colors. Therefore, in commonly assigned U.S. Pat. No. 7,011,421 and U.S. patent application Ser. No. 11/025,019, which are also incorporated herein by this reference, illumination devices are described that use LEDs in conjunction with fluorescent and/or phosphorescent dyes, allowing for the emission of light in hues that cannot ordinarily be achieved through the use of LEDs alone.

One problem with using LEDs in conjunction with fluorescent and/or phosphorescent dyes as described in U.S. Pat. No. 7,011,421 and U.S. patent application Ser. No. 11/025,019 is that the fluorescent and/or phosphorescent dyes must often be mixed in minute amounts to obtain the desired hue. It can be difficult to process such minute amounts of dye, thus making the desired hue difficult to achieve. Additionally, once the desired hue is achieved, any changes in the characteristics of the LEDs or the dyes will result in a change in the hue, which may make it difficult to correct or tune back to the desired hue.

Thus, there remains a need for an illumination device using LEDs in conjunction with fluorescent and/or phosphorescent dyes or other colorants that allows for ready tuning to achieve a desired hue.

### SUMMARY OF THE INVENTION

The present invention is an illumination device using LEDs in conjunction with fluorescent and/or phosphorescent dyes or other colorants, in which a desired hue can be achieved and finely tuned by adjusting the intensity of the LEDs.

One exemplary illumination device made in accordance with the present invention includes a first light source, a second light source, and a light-diffusing medium. The first light source emits light of a first hue and a first intensity. The second light source emits light of a second hue and a second intensity. The light-diffusing medium is positioned adjacent the first light source and the second light source, and thus receives light emitted from both the first light source and the second light source. The light-diffusing medium is composed of a light-transmitting material and a light color-converting material, such as some predetermined combination of one or more fluorescent dyes, phosphorescent dyes, and/or other dyes or colorants. The light color-converting material is selected to convert the light of the first hue into a light of a third hue, and to pass the light of the second hue with substantially no conversion. The light of the third hue is a combination of the light of the first hue (directly from the first light source) and the hue of the light converted by the light color-converting material. The light-diffusing medium thus emits light of a perceived hue that is a combination of the light of the third hue and the light of the second hue. By adjusting the relative intensities of the light emitted by the first light source and the second light source, the perceived hue can be readily transformed or tuned.

Another exemplary illumination device made in accordance with invention includes a first light source, a second light source, a third light source, and a light-diffusing medium. The first light source emits light of a first hue and a first intensity. The second light source emits light of a second hue and a second intensity. The third light source emits light of a fourth hue and a third intensity. The light-diffusing medium is again composed of a light-transmitting material and a light color-converting material. The light color-converting material is selected to convert the light of the first hue into a light of a third hue, and to pass the light of the second hue with substantially no conversion. In this embodiment, the light color-converting material also converts the light of the fourth hue (from the third light source) into a light of a fifth hue. The light-diffusing medium thus emits light of a perceived hue that is a combination of the light of the third hue, the light of the second hue, and the light of the fifth hue. By adjusting the intensity of the light emitted by the first light source, the second light source, and/or the third light source, the perceived hue of the light emitted by the light-diffusing medium can again be readily transformed or tuned.

### DESCRIPTION OF THE DRAWINGS

FIG. 1 is a block diagram of an exemplary illumination device made in accordance with the present invention;

FIG. 2 is a block diagram of another exemplary illumination device made in accordance with the present invention;

FIG. 3 is a block diagram of the exemplary illumination device of FIG. 2, in which the first light source is a blue LED, the second light source is a red LED, the third light source is a green LED, and the light-diffusing medium is composed of an acrylic compound with a fluorescent dye serving as the light color-converting material;

FIG. 4 is a side view of an exemplary illumination device for simulating neon lighting made in accordance with the present invention and incorporating the aspects of the illumination device of FIG. 3;

FIG. 5 is an end view of the exemplary illumination device of FIG. 4;

FIG. 6 is a sectional view of the exemplary illumination device of FIG. 4, taken along line 6-6 of FIG. 5;

FIG. 7 is a partial perspective view of the exemplary illumination device of FIG. 4; and

FIG. 8 is a CIE Chromaticity Diagram showing the reduction in the dynamic color range of the exemplary illumination device of FIG. 4 resulting from the use of a fluorescent dye as the light color-converting material.

### DETAILED DESCRIPTION OF THE INVENTION

The present invention is an illumination device using LEDs in conjunction with fluorescent and/or phosphorescent dyes or other colorants, in which a desired hue can be achieved and finely tuned by adjusting the intensity of the LEDs.

For purposes of the discussion that follows, it is important to recognize that most perceived “colors” are not representative of light of a single wavelength, but rather some combination of wavelengths. In this regard, the dominant color in light comprised of some combination of wavelengths is generally referred to as hue. In order to provide a mechanism to represent and identify all possible perceived colors, the Commission Internationale l'Eclairage (CIE) constructed the CIE Chromaticity Diagram, which is based on three ideal primary light colors of red, blue, and green. The CIE Chromaticity Diagram is a well-known tool for identifying colors and is well understood by one of ordinary skill in the art. Specifically, since the x-axis of this CIE Chromaticity Diagram represents the amount of ideal red that would be mixed with ideal blue, and the y-axis of the CIE Chromaticity Diagram represents the amount of ideal green that would be mixed with ideal blue, a desired color can be identified in terms of its x and y coordinates. It is also important to recognize that the chromaticity curve, which is representative of the visible spectrum, is commonly superimposed over the chart such that wavelengths within the visible spectrum are represented along this curve.

Furthermore, the CIE Chromaticity Diagram is also helpful in understanding mixtures of primary light colors. Specifically, if a straight line is drawn between two points on the chromaticity curve, for example from green with a wavelength of 510 nm to red with a wavelength of 700 nm, that straight line illustrates the range of colors that could be created and perceived by the human eye, depending on the relative amounts of primary light colors in the mixture, including various yellowish-green colors and oranges. It is also important to recognize that the central region of the CIE Chromaticity Diagram is representative of white, a combination of the three ideal primary light colors. If any straight line between two colors on the chromaticity curve passes through this central region, those two colors can be mixed to create a perceived white color.

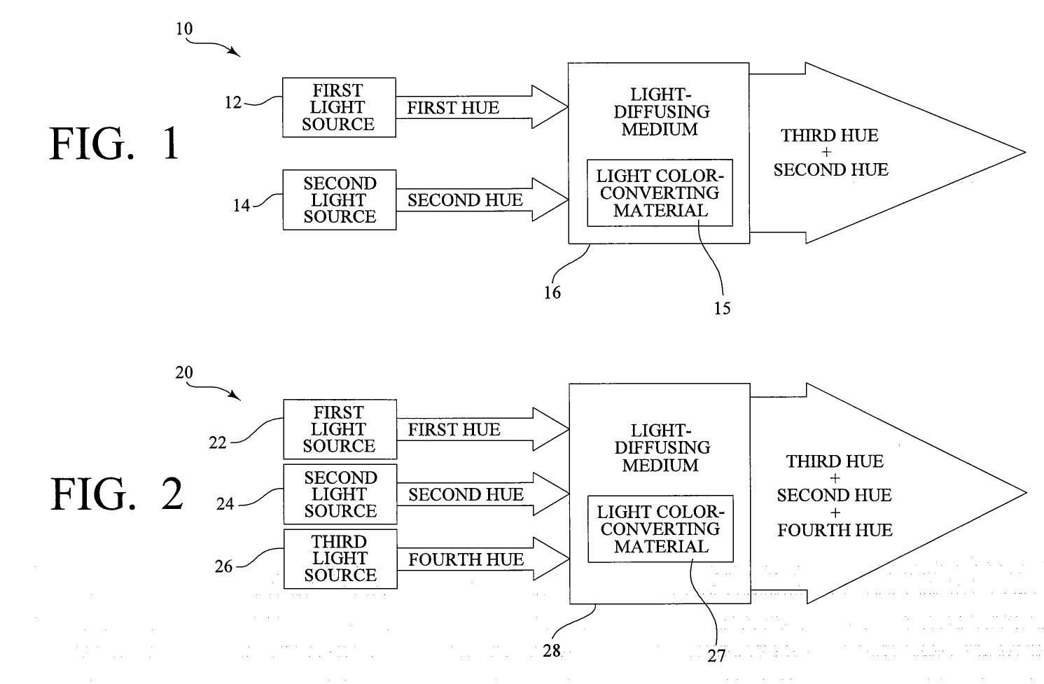

Returning to the present invention, FIG. 1 is a block diagram of an exemplary illumination device 10 made in accordance with the present invention, which includes a first light source 12, a second light source 14, and a light-diffusing medium 16. The first light source 12 emits light of a first hue and a first intensity. The second light source 14 emits light of a second hue and a second intensity. The light-diffusing medium 16 is positioned adjacent the first light source 12 and the second light source 14, and thus receives light emitted from both the first light source 12 and the second light source 14. The light-diffusing medium 16 is composed of a light-transmitting material (such a substantially translucent acrylic compound, polyurethane, or similar material) and a light color-converting material 15. Applicants have determined that one appropriate material for the light-diffusing medium is an acrylic resin, for example, Plexiglas® DR Impact Grade Acrylic Resin, manufactured and distributed by Arkema, Inc. of Puteaux, France and Philadelphia, Pa. (Plexiglas® is a registered trademark of Arkema, Inc.). When using such an acrylic resin, the light color-converting material 15 may be some predetermined combination of one or more fluorescent dyes, phosphorescent dyes, and/or other dyes or colorants that are mixed into the acrylic resin. For example, and as further discussed below, suitable fluorescent dyes include Lumogen™ F240 (orange), Lumogen™ F170 (yellow), and Lumogen™ F285 (pink), each of which may be acquired from BASF Corporation of Mount Olive, N.J.

Referring still to FIG. 1, the light color-converting material 15 is selected to convert the light of the first hue into a light of a third hue, and to pass the light of the second hue with substantially no conversion. The light of the third hue is thus a combination of the light of the first hue (directly from the first light source 12) and the hue of the light converted by the light color-converting material 15. If some combination of fluorescent dyes and/or phosphorescent dyes is used as the light color-converting material 15, the dyes would absorb some of the energy from the light emitted from first light source 12, and then emit a lower-energy light. Therefore, the light of the third hue is a combination of the light emitted from the first light source 12 and the lower-energy light emitted by the dyes. Of course, if the dyes absorbed all light emitted from the first light source 12, then the light of the third hue would be solely the lower-energy light emitted by the dyes.

Higher densities of the light color-converting material 15 in the light-diffusing medium 16 will produce light of the third hue that has higher amounts of the hue of the light converted by the light color-converting material 15 and lower amounts of the light of the first hue (directly from the first light source 12). Likewise, lower densities of the light color-converting material 15 in the light-diffusing medium 16 will produce light of the third hue that has lower amounts of the hue of the light converted by the light color-converting material 15 and higher amounts of the light of the first hue (directly from the first light source 12).

The light-diffusing medium 16 emits light of a perceived hue that is a combination of the light of the third hue and the light of the second hue. By adjusting the relative intensities of the light emitted by the first light source 12 and the second light source 14, the perceived hue can be readily transformed or tuned.

With respect to the exemplary embodiment shown in FIG. 1, the first hue (first light source 12 and the second hue (second light source 14) thus constitute two ends of a line on the CIE Chromaticity Diagram. The light color-converting material transforms the first hue to the third hue, which moves one end of the line. Thus, the light-diffusing medium 16 and associated light color-converting material 15 is a “transformation matrix,” which shifts the line on the CIE Chromaticity Diagram to a new set of coordinates. By adjusting the intensity of the light emitted by the first light source 12 and/or the second light source 14, hues represented by any point on the line are achievable.

FIG. 2 is a block diagram of a second exemplary illumination device 20 made in accordance with invention, which includes a first light source 22, a second light source 24, a third light source 26, and a light-diffusing medium 28. The first light source 22 emits light of a first hue and a first intensity. The second light source 24 emits light of a second hue and a second intensity. The third light source 26 emits light of a fourth hue and a third intensity. As with the embodiment described above with respect to FIG. 1, the light-diffusing medium 28 is composed of a light-transmitting material (such a substantially translucent acrylic compound, polyurethane, or similar material) and a light color-converting material 27. The light color-converting material 27 is again selected to convert the light of the first hue into a light of a third hue, and to pass the light of the second hue with substantially no conversion. In this embodiment, the light color-converting material 27 also converts the light of the fourth hue (from the third light source 26) into a light of a fifth hue. The light-diffusing medium 28 thus emits light of a perceived hue that is a combination of the light of the third hue, the light of the second hue, and the light of the fifth hue. By adjusting the intensity of the light emitted by the first light source 22, the second light source 24, and/or the third light source 26, the perceived hue of the light emitted by the light-diffusing medium 28 can be readily transformed or tuned. Advantageously, by selecting the first light source 22 and a light color-converting material 27 that produces light of the third hue that is close to a desired hue, that hue can be finely tuned by adjusting the intensity of the second light source 24 and/or the third light source 26.

With respect to the exemplary embodiment shown in FIG. 2, the first hue, the second hue, and the fourth hue constitute a basic color region or triangle on the CIE Chromaticity Diagram. The light color-converting material 27 transforms the triangle to another region where the third hue, the second hue, and the fifth hue define the triangle. By adjusting the intensity of the light emitted by the first light source 22, the second light source 24, and/or the third light source 26, hues represented by any point bounded by the triangle are achievable.

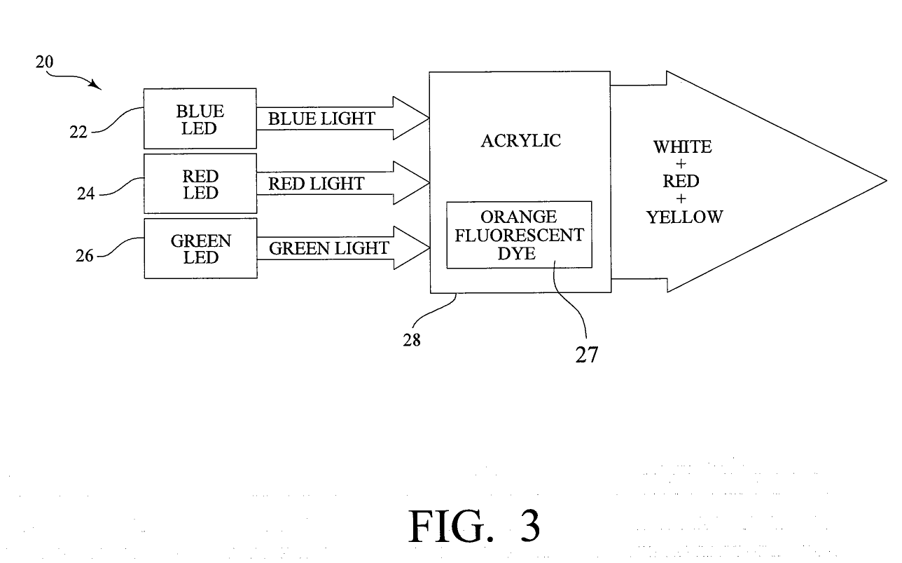

FIG. 3 is a block diagram of the exemplary illumination device of FIG. 2, in which the first light source 22 is a blue LED, the second light source 24 is a red LED, and the third light source 26 is a green LED. The red, green, and blue LEDs may be combined in a single RGB LED package capable of producing red, green, and blue hues in any combination of intensities. Such RGB LED packages are available from a number of commercial suppliers, including, for example, Color Kinetics Incorporated of Boston, Mass. The light-diffusing medium 28 is composed of an acrylic resin, for example, Plexiglas® DR Impact Grade Acrylic Resin, manufactured and distributed by Arkema, Inc. of Puteaux, France and Philadelphia, Pa. The light color-converting material 27 is a Lumogen™ F240 (orange) dye, available from BASF Corporation of Mount Olive, N.J.

In this exemplary embodiment, and as shown in FIG. 3, the fluorescent dye converts the blue light from the first light source 22 to white (third hue), and converts the green light from the third light source 26 to yellow (fourth hue). However, the red light from the second light source 24 passes through the light-diffusing medium 28 and fluorescent dye 27 with substantially no conversion. Advantageously, where white is the desired color, instead of requiring red, green and blue LEDs to produce white, only the blue LED (first light source 22) and the orange fluorescent dye are required to produce the white light. The red and yellow light emitted from the red LED (second light source 24) and the green LED (third light source 26) can then be used to fine tune the white light. This makes it possible to obtain white light with color temperatures that are difficult to obtain with only a blue LED and fluorescent dye alone (e.g., <3000 degrees Kelvin). Also, by providing a means by which to control and tune the light to a desired hue, small variations in dye densities can be overcome. In other words, the problem of rigidly controlling the minute amounts of dyes that are used is alleviated.

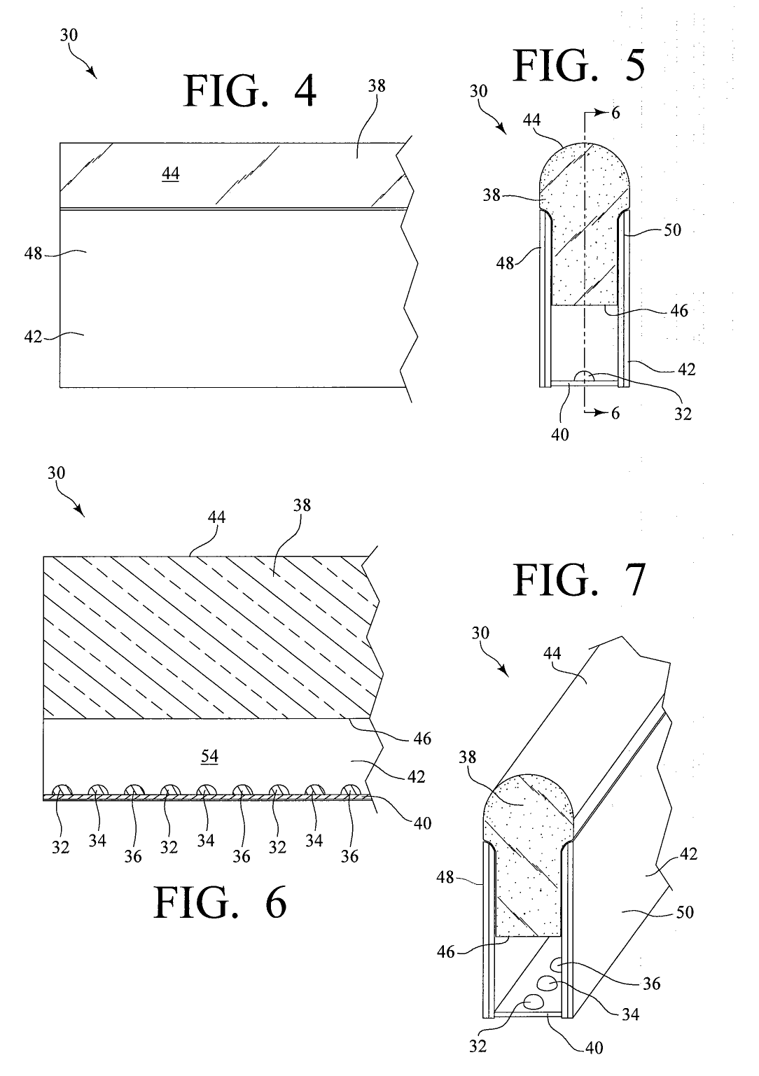

FIGS. 4-7 show an exemplary illumination device 30 for simulating neon lighting and incorporating the aspects of the illumination device described above with reference to FIG. 3. As with the embodiment described above with reference to FIG. 3, the illumination device 30 is generally comprised of a first light source 32, a second light source 34, and a third light source 36. In this exemplary embodiment, the light sources 32, 34, 36 are part of a single package, with the first light source 32 comprising an array of blue LEDs, the second light source 34 comprising an array of red LEDs, and the third light source 36 comprising an array of green LEDs. These arrays of LEDs are arranged to form an alternating pattern of blue, red, and green LEDs along the length of the illumination device 30, as best shown in FIG. 6.

The exemplary illumination device 30 shown in FIGS. 4-7 further includes a light-diffusing medium 38, a circuit board 40 for controlling the lights sources 32, 34, 36 and connecting them to a power supply (not shown), and a housing 42. In this regard, the exemplary illumination device 30 shown in FIGS. 4-7 has a structure and construction similar to that described in U.S. Pat. Nos. 6,592,238 and 6,953,262. Accordingly, and as described in U.S. Pat. Nos. 6,592,238 and 6,953,262, the light-diffusing medium 38 is a rod-like member with a curved surface serving as a light-emitting surface 44 and an internal surface that serves as a light-receiving surface 46. Although such a geometry is desirable because it simulates a neon tube, the light-diffusing medium 38 could also be produced in various other shapes without departing from the spirit and scope of the present invention. In any event, light entering the light-diffusing medium 38 of the illumination device 30 through the light-receiving surface 46 is scattered and diffused so as to be perceived as being substantially uniform over the light-emitting surface 44.

In this exemplary embodiment, as with the embodiment described above with reference to FIG. 3, the light-diffusing medium 38 is composed of an acrylic resin, for example, Plexiglas® DR Impact Grade Acrylic Resin, manufactured and distributed by Arkema, Inc. of Puteaux, France and Philadelphia, Pa. The color-converting material (not shown) in the light-diffusing medium 38 is a Lumogen™ F240 (orange) dye, available from BASF Corporation of Mount Olive, N.J.

Referring still to FIGS. 4-7, the light sources 32, 34, 36 and any accompanying electrical accessories, including the circuit board 40, are positioned within the housing 42. The housing 42 generally comprises a pair of side walls 48, 50 defining an open-ended channel that extends substantially the length of the light-diffusing medium 38. The housing 42 preferably not only functions to house the light sources 32, 34, 36 and any accompanying electrical accessories, but also to collect light not emitted directly into the light-receiving surface 46 and redirect it to the light-diffusing medium 38. As such, the internal surfaces of the side walls 48, 50 and the circuit board 40 may be constructed of or coated with a light-reflecting material (e.g., white paint or tape) in order to increase the light collection efficiency by reflecting the light incident upon the internal surfaces of the housing 42 into the light-diffusing medium 38.

As a further refinement, from a viewer's perspective, it is desirable that the visual appearance of the housing 42 not be obtrusive with respect to the glowing, light-emitting surface 44 of the light-diffusing medium 38. Therefore, the external surfaces of the housing 42 may be constructed of or coated with a light absorbing material (e.g., black paint or tape).

As with the embodiment described above with reference to FIG. 3, the fluorescent dye is selected to convert the blue light from the first light source 32 to white, and convert the green light from the third light source 36 to yellow. However, the red light from the second light source 34 passes through the light-diffusing medium 38 and fluorescent dye with substantially no conversion. The light-diffusing medium 38 thus emits light of a perceived hue that is a combination of the white, yellow, and red lights, and the perceived hue can then be readily tuned by adjusting the intensity of the blue, red and/or green LEDs.

Advantageously, the light sources 32, 34, 36 and the light-diffusing medium 38 are positioned relative to one another with the light entering the light-diffusing medium 38 being scattered and diffused so as to be perceived as being substantially uniform over the light-emitting surface 44.

For purposes of example, the exemplary illumination device 30 shown in FIGS. 4-7 was constructed with the light-diffusing medium 38 composed of Plexiglas® DR Impact Grade Acrylic Resin. In a first experiment, no dye or other color-converting material was incorporated into light-diffusing medium 38. The resultant light intensity (lux) was measured, and the coordinates on the CIE Chromaticity Diagram were determined as the intensities of the respective first, second, and third light sources 32, 34, 36 were adjusted. Also, at selected coordinates, the approximate color temperature was determined. The experimental data is included in Table A.

Then, the light-diffusing medium 38 of the exemplary illumination device 30 shown in FIGS. 4-7 was provided with a Lumogen™ F240 (orange) dye at an approximate density of 0.63 grams of dye per 45 kg of acrylic resin. The resultant light intensity (lux) was again measured, and the coordinates on the CIE Chromaticity Diagram were determined, as the intensities of the respective first, second, and third light sources 32, 34, 36 were adjusted. Also, at selected coordinates, the approximate color temperature was determined. This experimental data is also included in Table A.

TABLE A

| LIGHT | | | | | | | LUMOGEN ™ F240 | | | |
|---|---|---|---|---|---|---|---|---|---|---|
| SOURCES | | | | | | | (ORANGE) DYE | | | |
| (mA) | | | NO DYE | | | Temp | | | | Temp |
| R | G | B | lux | x | y | (K) | lux | x | y | (K) |
| 34 | 71 | 71 | 637 | 0.27 | 0.22 | | 603 | 0.51 | 0.41 | |
| 25 | 71 | 71 | 575 | 0.24 | 0.21 | | 563 | 0.50 | 0.42 | 2316 |
| 17 | 71 | 71 | 536 | 0.22 | 0.21 | | 550 | 0.49 | 0.43 | 2532 |
| 8 | 71 | 71 | 492 | 0.18 | 0.21 | | 520 | 0.47 | 0.44 | 2873 |
| 34 | 0 | 0 | 184 | 0.72 | 0.28 | | 127 | 0.72 | 0.28 | |
| 34 | 71 | 71 | 647 | 0.28 | 0.22 | | 627 | 0.52 | 0.41 | |
| 34 | 53 | 71 | 530 | 0.27 | 0.19 | | 562 | 0.52 | 0.40 | |
| 34 | 35 | 71 | 451 | 0.28 | 0.17 | | 507 | 0.52 | 0.39 | |
| 34 | 18 | 71 | 345 | 0.28 | 0.14 | | 460 | 0.52 | 0.38 | |
| 0 | 71 | 0 | 371 | 0.18 | 0.72 | | 205 | 0.47 | 0.52 | 3261 |
| 34 | 71 | 71 | 641 | 0.27 | 0.22 | | 628 | 0.52 | 0.41 | |
| 34 | 71 | 53 | 601 | 0.29 | 0.25 | 11520 | 528 | 0.53 | 0.41 | |
| 34 | 71 | 35 | 578 | 0.32 | 0.28 | 6384 | 471 | 0.54 | 0.41 | |
| 34 | 71 | 18 | 563 | 0.38 | 0.36 | 3894 | 393 | 0.57 | 0.40 | |
| 0 | 0 | 71 | 83 | 0.14 | 0.04 | | 296 | 0.43 | 0.42 | 3347 |
| 0 | 71 | 71 | 448 | 0.15 | 0.20 | | 490 | 0.44 | 0.46 | 3310 |
| 34 | 0 | 71 | 261 | 0.29 | 0.11 | | 414 | 0.54 | 0.37 | |
| 34 | 71 | 0 | 546 | 0.48 | 0.48 | | 313 | 0.60 | 0.40 | |

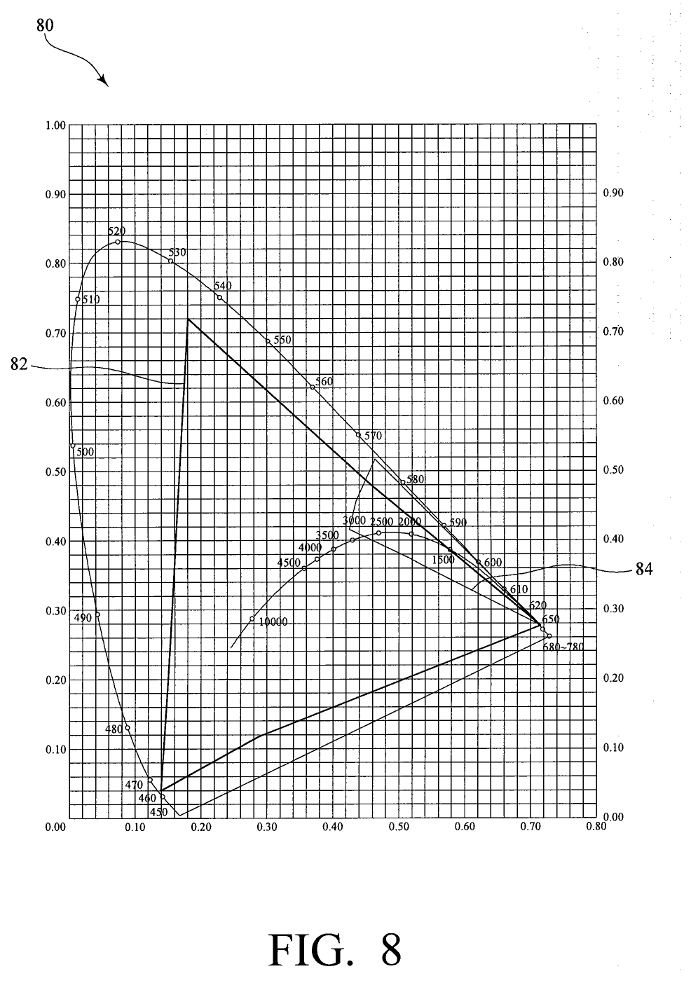

FIG. 8 shows a CIE Chromaticity Diagram with the data from Table A plotted thereon. The larger triangle 82 represents the data when there is no dye or other light color-converting material in the light-diffusing medium 38. The smaller triangle 84 represents the data when the light diffusing medium 38 includes the Lumogen™ F240 (orange) dye. One significant observation is that the smaller triangle 84 represents a compression of the bounded region, or a reduction in the dynamic color range of the illumination device 30. However, the resultant hue can be more readily tuned to a desired hue within the area bounded by the smaller triangle 84 by adjusting the intensities of the intensities of the respective first, second, and third light sources 32, 34, 36, which makes it possible to produce precise colors, including pure or saturated colors along the outer perimeter of the chromaticity curve and white light with a color temperature below 3000 degrees Kelvin, but without unduly sacrificing the resultant light intensity.

One of ordinary skill in the art will recognize that additional embodiments are possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A illumination device, comprising:
a first light source emitting light of a first hue and a first intensity;
a second light source emitting light of a second hue and a second intensity;
a light-diffusing medium positioned adjacent said first light source and said second light source for receiving light emitted from said first light source and said second light source, said light-diffusing medium being composed of a light-transmitting material and a light color-converting material, said light color-converting material selected
to convert said light of the first hue into a light of a third hue, and
to pass said light of the second hue with substantially no conversion;
whereby said light-diffusing medium emits light of a perceived hue that is a combination of said light of the third hue and said light of the second hue; and
whereby said perceived hue is readily tuned by adjusting one or both of the first intensity of said first light source and the second intensity of said second light source.

2. The illumination device as recited in claim 1, in which said light color-converting material is one or more fluorescent dyes, one or more phosphorescent dyes, or a combination thereof.

3. The illumination device as recited in claim 1, in which said first light source is an array of light-emitting diodes.

4. The illumination device as recited in claim 3, in which said second light source is an array of light-emitting diodes.

5. The illumination device as recited in claim 4, in which said arrays of light-emitting diodes are arranged to form an alternating pattern.

6. The illumination device as recited in claim 1, in which said light-transmitting material is a substantially translucent acrylic compound.

7. The illumination device as recited in claim 1, in which said light-diffusing medium is a substantially rod-like member, and the light-transmitting material of said rod-like member scatters and diffuses light entering a light-receiving surface of said rod-like member so as to be perceived as being substantially uniform over a light-emitting surface of said rod-like member.

8. The illumination device as recited in claim 7, in which said light-transmitting material is a substantially translucent acrylic compound.

9. The illumination device as recited in claim 7, and further comprising a housing that receives said first and second light sources and associated electrical accessories.

10. The illumination device as recited in claim 9, in which said housing generally comprises a pair of side walls that define an open-ended channel, with said first and second light sources being received and housed in said open-ended channel.

11. The illumination device as recited in claim 10, in which internal surfaces of said side walls are constructed of or coated with a light-reflecting material.

12. A illumination device, comprising:
a first light source emitting light of a first hue and a first intensity;
a second light source emitting light of a second hue and a second intensity;
a third light source emitting light of a fourth hue and a third intensity;
a light-diffusing medium positioned adjacent said light sources for receiving light emitted from said light sources, said light-diffusing medium being composed of a light-transmitting material and a light color-converting material, said light color-converting material selected
to convert said light of the first hue into a light of a third hue,
to pass said light of the second hue with substantially no conversion, and
to convert said light of the fourth hue into a light of a fifth hue;
whereby said light-diffusing medium emits light of a perceived hue that is a combination of said light of the third hue, said light of the second hue, and said light of the fifth hue; and
whereby said perceived hue is readily tuned by adjusting one or more of the first intensity of said first light source, the second intensity of said second light source, and the third intensity of said third light source.

13. The illumination device as recited in claim 12, in which said light color-converting material is one or more fluorescent dyes, one or more phosphorescent dyes, or a combination thereof.

14. The illumination device as recited in claim 12, in which each of said first, second, and third light sources is an array of light-emitting diodes.

15. The illumination device as recited in claim 14, in which said first, second, and fourth hues are blue, green, and red.

16. The illumination device as recited in claim 15, in which said first, second, and third light sources are combined in a single RGB LED package.
